(19) United States
(12) Patent Application Publication
(10) Pub. No.: US 2014/0291259 A1
(43) Pub. Date: Oct. 2, 2014

(54) SEPARATION METHOD AND APPARATUS

(71) Applicants: Martin Richard Gravett, Salisbury (AU); Paul Austin Wootton, Pallara (AU); Timothy James Elkington, Sourth Perth (AU)

(72) Inventors: Martin Richard Gravett, Salisbury (AU); Paul Austin Wootton, Pallara (AU); Timothy James Elkington, Sourth Perth (AU)

(73) Assignee: ANAECO LIMITED, Bentley, Western Australia (AU)

(21) Appl. No.: 14/342,990

(22) PCT Filed: Sep. 6, 2012
(86) PCT No.: PCT/AU2012/001059

§ 371 Date: Jun. 10, 2014

(30) Foreign Application Priority Data
Sep. 6, 2011 (AU) 2011903619

(51) Int. Cl. B01D 21/02

(52) U.S. Cl. CPC B01D 21/02
USPC 210/770; 210/800; 210/797; 210/780; 210/259

(57) ABSTRACT

A separation method (10) comprising the following method steps: (i) Passing an organic waste material to a primary washing step (16) in which a clean organic stream (18) and a fraction with a specific gravity of greater than 1 (20) are produced; (ii) Passing the clean organic stream (18) from step (i) to a drainage step (22) to remove free water therefrom; and (iii) Passing the organic material product (24) of step (ii) to a dewatering step (26) in which the water content of the organic material is reduced to a level suitable for passing to a bioconversion process. An apparatus is also described.

### FIELD OF THE INVENTION

The present invention relates to a separation method and apparatus.

More particularly, the separation method and apparatus of the present invention are intended for use in the removal of contaminants from the organic fraction of municipal solid waste (“OFMSW”).

### BACKGROUND ART

It is known that solid organic waste material may be treated under either anaerobic or aerobic conditions to produce a bioactive, stable end product that, for example, may be used as compost for gardens. This process is achieved through the action of, respectively, anaerobic or aerobic microorganisms that are able to metabolise the waste material to produce the bioactive, stable end product.

It is also known that the aerobic decomposition of solid organic waste material takes place in the presence of oxygen. The temperature of the waste material rises as some of the energy produced during aerobic decomposition is released as heat, often reaching temperatures of approximately 75° C. under ambient conditions. The solid end product is often rich in nitrates which are a readily bio-available source of nitrogen for plants, making the end product particularly suitable as a fertiliser.

It is further known that the anaerobic digestion of solid organic waste material takes place in the absence of oxygen. Anaerobic microbial metabolism is understood to be optimised when the organic material is heated to temperatures at which mesophilic or thermophilic bacteria are operative. The process of anaerobic microbial metabolism results in the production of biogas, in turn predominantly methane and carbon dioxide. The solid product of the process is often rich in ammonium salts. Such ammonium salts are not readily bio-available and are, consequently, generally treated under conditions in which aerobic decomposition will occur. In this manner the material is used to produce a product that is bio-available.

Typically, systems for the biodegradation of organic waste material are directed to either aerobic or anaerobic processes. However, there are a small number of systems that have sought to combine both anaerobic and aerobic biodegradation processes. The processes of German Patent 4440750 and International Patent Application PCT/DE1994/000440 (WO 1994/024071) each describe the combination of an anaerobic fermentation unit and an aerobic composting unit. Importantly, these systems describe discrete and separate vessels for the aerobic and anaerobic biodegradation processes.

International Patent Application PCT/A000/00865 (WO 01/05729) describes an improved process and apparatus in which many of the inefficiencies of the previous processes and apparatus are overcome. The improved process and apparatus are characterised at a fundamental level by the sequential treatment of organic waste material in a single vessel, through an initial aerobic step to raise the temperature of the organic waste material, an anaerobic digestion step and a subsequent aerobic treatment step. During the anaerobic digestion step a process water or inoculum containing micro organisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. It is further described that the water introduced during anaerobic digestion may be sourced from an interconnected vessel that has undergone anaerobic digestion.

The processing of the organic fraction of municipal solid waste (“OFMSW”) from material recycling facilities, such as are described above, is presently impacted by the fact that non-organic material can pass too regularly into this part of the process. This negatively impacts the efficiency of the digestion and composting processes employed, and also on the compost product obtained. That is, a compost product that contains glass, for example, is not as useful or as valuable as one that doesn't.

The presence of glass and grit in the process streams when attempting to process OFMSW also causes wear to the process equipment which impacts negatively on its operation and effective life.

European Patent Application 86201987.4 (Publication 0228724 A2) describes a separator for aggregate said to be useful in the separation of heavy aggregate, even in the form of dust, from organic material and compost. The separator comprises a separation vessel filled with water, a device to force the immersion of the organic material with entrained aggregate in the separation vessel, a weir over which organics may pass and a means, in the form of a screw conveyor, for withdrawing the aggregate.

A similar arrangement has been described by Manser & Keeling (1996): Practical Handbook of Processing Recycling Municipal Waste. Boca Raton, Fla., USA: CRC Press. However, these prior art arrangements suffer from a number of difficulties or inadequacies. These include difficulties in establishing a uniform flow rate in the raw waste infeed. Non-uniform feed resulted in disruption to retention time and short circuiting. Further, there was a tendency for the circulating fluid to become increasingly viscous, resulting in glass and grit being carried over with the organic fraction.

U.S. Pat. No. 5,292,075 describes a method and apparatus for the reclamation of paper and plastics from disposable nappies/diapers. The method described requires a first shredding step that is followed by a washing step. The washing step, conducted as a batch process, separates plastics materials from water and pulp, the latter containing organic filler (such as wood or corn) together with acrelites (the absorbent gel in nappies). The shredding step involves the addition of several cleaning agents as well as calcium chloride so as to neutralise the acrelites present prior to washing. The pulp is subsequently passed to a dehydrating step that utilises a screen and roller press. The process described is very specifically designed for the disposal of nappies/diapers and the combination of shredding and batch washing steps described would not be capable of handling an organic waste material that was intended for subsequent use in a bioconversion process, let alone doing this in a continuous manner. In particular, the process of U.S. Pat. No. 5,292,075 does not have the capacity to handle glass and grit, or similar contaminants, that may be present. Still further, the process of U.S. Pat. No. 5,292,075 loses significant volumes of process water to sewage.

The separation method and apparatus of the present invention have as one object thereof to overcome substantially one or more of the abovementioned problems of the prior art, or to at least provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a separation method comprising the following method steps:
(i) Passing an organic waste material to a primary washing step in which a clean organic stream and a glass and grit fraction are produced;
(ii) Passing the clean organic stream from step (i) to a drainage step to remove free water therefrom; and
(iii) Passing the organic material product of step (ii) to a dewatering step in which the water content of the organic material is reduced to a level suitable for passing to a bioconversion process.

Preferably, the glass and grit fraction produced in step (i) is passed to a secondary washing step.

Still preferably, process water is fed to at least one tank from which it may be fed in turn to the primary and secondary washing steps. At least a portion of the water fed to the tank is passed to a filter means prior to feeding to the primary and secondary washing steps. A further portion of the filtered water is preferably used to clean the glass and grit fractions and the screens, employed in the drainage step.

In one form of the present invention the organic waste material is an organic fraction of municipal solid waste.

In one form of the present invention the fraction with a specific gravity greater than 1 comprises a glass and grit fraction.

Preferably, the primary washing step comprises directing the organic waste material into a body of water, in which glass and grit settle and light organic material is able to pass over a weir provided in the body of water before passing to the drainage step.

Still preferably, the secondary washing step is conducted in the same manner as the primary washing step with a view to separating a significant proportion of any organic material entrained with the glass and grit from the primary washing step.

The drainage step preferably comprises the introduction of separated organic material into a trough about which is provided a rotating screen, whereby the organic material is discharged over a weir in the trough onto the rotating screen, in which process the organic material is subjected to a shear force with organic material being held in the screen whilst water passes therethrough.

The dewatering step preferably comprises the passing of the organic product of the drainage step to a screw press having an adjustable outlet cap against which the conveyed organic material bears before leaving the dewatering step. The ease with which the organic product is able to pass the adjustable cap preferably governs the subsequent moisture content of the organic product.

In accordance with the present invention there is further provided an apparatus for the separation or organic material from material with a specific gravity greater than 1, comprising a primary washer in which a clean organic stream and a glass and grit fraction are produced, a drainer to remove free water from the clean organic stream, and a dewaterer in which the water content of the organic material is reduced to a level suitable for passing to a bioconversion process.

Preferably, the apparatus further comprises a secondary washer.

Still preferably, the apparatus further comprises at least one tank to and from which water may be fed. A filter means may be provided prior to water being fed to the primary and secondary washers.

In one form of the present invention the organic waste material is an organic fraction of municipal solid waste.

Preferably, the fraction with a specific gravity greater than 1 comprises a glass and grit fraction.

Preferably, the primary washer comprises a body of water, in which glass and grit settle and light organic material is able to pass over a weir provided in the body of water before passing to the drainage step.

Still preferably, the secondary washer is provided in substantially the same form as the primary washer, with a view to separating a significant proportion of any organic material entrained with the glass and grit from the primary washer.

The drainer preferably comprises an elongate trough in which separated organic material is introduced, about which is provided a rotating screen. Preferably, a weir is provided in the trough whereby the organic material is discharged over that weir onto the rotating screen. In which process the organic material is subjected to a shear force with organic material being held in the screen whilst water passes therethrough.

The dewaterer preferably comprises a screw press having an adjustable outlet cap against which a conveyed organic material bears before leaving the dewaterer. The ease with which the organic product is able to pass the adjustable cap preferably governs the subsequent moisture content of the organic product.

### BRIEF DESCRIPTION OF THE DRAWINGS

The present invention will now be described, by way of example only, with reference to one embodiment thereof and the accompanying drawings, in which:

FIG. 1 is a schematic flow-sheet of a separation method and apparatus in accordance with, the present invention;

FIG. 2 is a diagrammatic cross-sectional view through a primary separator of the method and apparatus of FIG. 1;

FIG. 3 is a diagrammatic sectional view of a drainer of the method and apparatus of FIG. 1;

FIG. 4 is an end view of the drainer of FIG. 3; and

FIG. 5 is a perspective and partial sectional view of a screw press of the method and apparatus of FIG. 1.

### BEST MODE(S) FOR CARRYING OUT THE INVENTION

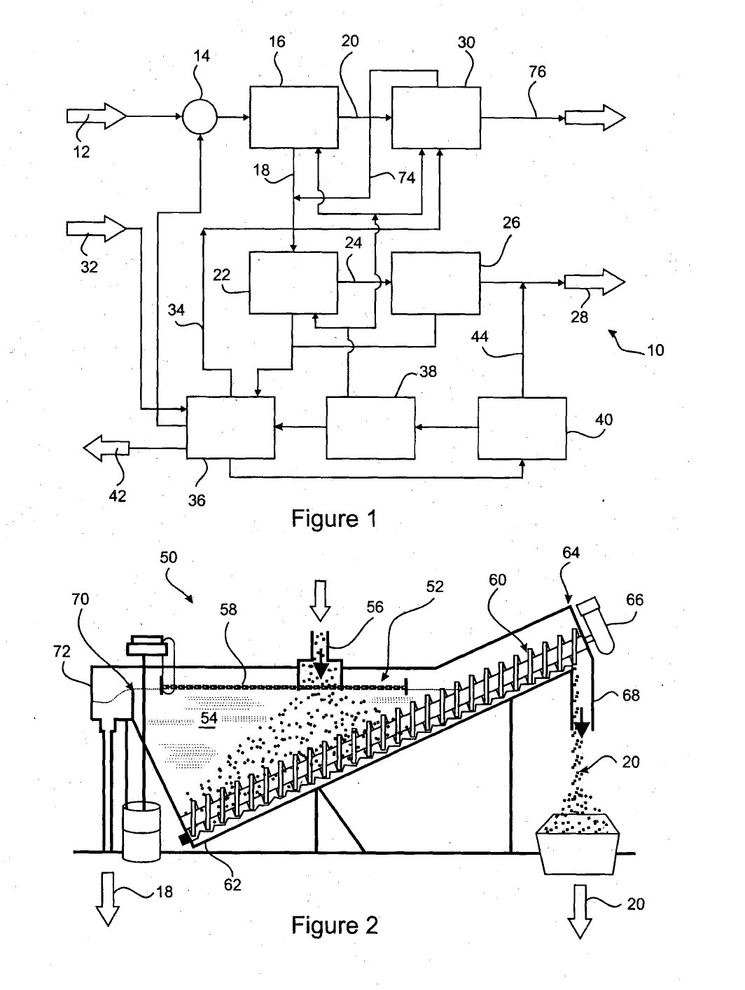

In FIG. 1 there is shown a separation method 10 in accordance with the present invention. In the separation method 10 a screened organic waste material 12, for example an organic fraction of municipal solid waste (“OFMSW”) screened to less than about 40 mm, is passed to a mixer 14, in which the OFMSW is combined with water before being passed to a primary washing step 16 in which a clean organic stream 18 and a fraction with a specific gravity greater than 1, for example a glass and grit fraction 20, are produced.

The clean organic stream 18 is passed to a drainage step 22 to remove free water therefrom. The organic material product 24 of the drainage step 22 is passed to a dewatering step 26 in which the water content of the organic material is reduced to a level suitable for passing to a subsequent bioconversion process 28.

The glass and grit fraction 20 produced in the primary washing step 16 is passed to a secondary washing step 30. The secondary washing step 30 is fed with process water 34 from a tank 36. The tank 36 receives water from the drainage step 22, the dewatering step 26, a tank 38, and water 32. Water 42 excess to the requirements of the separation method 10 is exported from tank 36. Water from the tank 36 is used in the mixer 14 as described hereinabove. Additionally, a portion of the water from tank 36 is passed to a filter means, for example a vibrating screen filter 40, before a supernatant therefrom is passed then to tank 38. Filtered water from tank 38 is passed to the primary 16 and the secondary 30 washing steps and shower means (not shown) to clean screens in drainage step 22 and to wash the glass and grit fraction 20 and 76. The tanks 36 and 38 may comprise two compartments of a single tank, separated by a baffle (not shown).

The filter 40 removes small organic particles from the process water from tank 36 which prevents that water from becoming too contaminated with excess solids. The small organic particles removed by the filter are discharged therefrom in a stream 44 to combine with the organic product resulting from the dewatering step 26 prior to passing to the bioconversion process 28. The use of continuously filtered water to feed the washers 16 and 30 is understood to increase the separation efficiency achieved therein.

In FIG. 2 there is shown a primary washer 50 such as is used in the primary washing step 16. The primary washer 50 comprises a reservoir 52 that contains a body of water 54. An inlet 56 directs the incoming flow of OFMSW into the body of water 54 and a baffle 58 across the top of the body of water 54 minimises any likelihood of short-circuiting by the OFMSW.

The primary washer 50 further comprises an inclined screw conveyor having a shafted screw 60 extending from a base 62 of the reservoir 52 to a remote, and elevated, end 64 at which is provided a motor 66 to drive the shafted screw 60. An outlet 68 for the glass and grit fraction 20 is provided at the remote end 64. The glass and grit from the OFMSW introduced into the reservoir 52 and the body of water 54 settles, as it is of a specific. gravity >1, toward the base 62, from where it is conveyed by the shafted screw 60 to the outlet 68.

Still further, the primary washer 50 comprises a weir 70 and outlet chamber 72. The majority of the light organic material from the OFMSW floats in the body of water 54 and is able to pass over the weir 70 into the outlet chamber, from where it passes from the primary washer as the clean organic stream 18.

The secondary washing step 30 employs a secondary washer (not shown) which is of substantially the same construction as the primary washer 50 but is of smaller size. The two stage separation provided by way of the combined primary and secondary washing steps 16 and 30 provides an efficient separation of grit and glass from organic material whilst maintaining a relatively small plant footprint.

It is envisaged that the primary washer 50 is to be configured to maximise grit removal. A consequence of this is that a proportion of the organic fraction present is entrained in the glass and grit fraction 20 discharged from the primary washer 50. The secondary washing step 30 separates out this entrained portion of the organic fraction and discharges them to the drainage step 22 by way of organic discharge line 74, as shown in FIG. 1. A heavier glass and grit stream 76 is produced by the secondary washing step 30, again in similar manner to that shown for the primary washer 50.

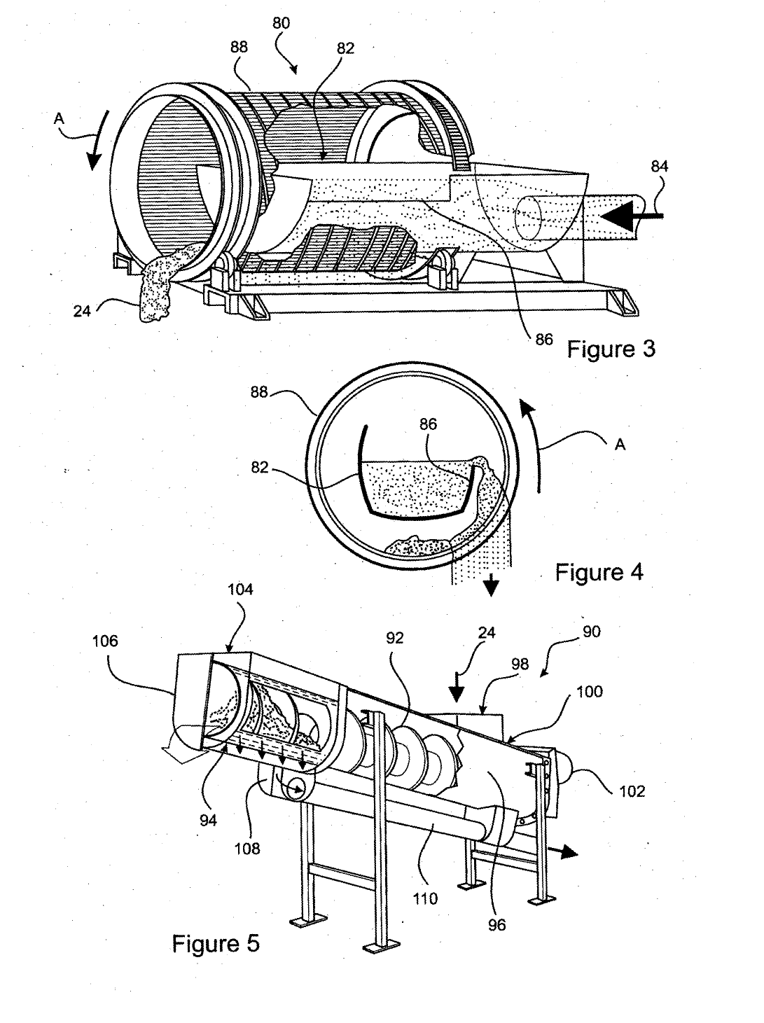

The clean organic streams from the primary and secondary washing steps 16 and 30, respectively, are passed to the drainage step 22. The moisture content of the feed to the drainage step 22 is dependent upon dilution rate but the Applicants anticipate a moisture content of between about 90 to 97%, for example about 95%. As shown in FIGS. 3 and 4, the drainage step 22 utilises a drainer 80 comprising an elongate trough 82 into which the clean organic streams are directed by way of an inlet 84. The trough 82 has provided therein a weir 86. A rotating screen 88 is provided surrounding the elongate trough 82 and which rotates thereabout.

The clean organic streams from the primary and secondary washing steps 16 and 30, respectively, pass into the elongate trough 82 and are discharged over the weir 86 provided therein and cascade onto the rotating screen 88. The rotating screen 88 rotates in a direction (designated by arrow A) which is counter to the direction of the cascade, as best seen in FIG. 3. This relationship imparts a shear force onto the organic material as it impacts on the rotating screen 88. This shearing force improves the efficiency of the separation of the organic material product 24 from the water that passes through the rotating screen 88. The separated water from this step 22 is passed to tank 36 as described hereinabove.

The organic material product 24 passes to the dewatering step 26, utilising a screw press 90. The moisture content of the organic material product 24 is in the range of about 70 to 90%, for example about 80%. The screw press 90 acts to reduce the water content of the clean organic stream to produce a product that is suitable for feeding to the organics bioconversion process 28. The moisture content of the discharge from the dewatering step 26 is about 40 to 60%, for example about 50%.

The screw press 90 comprises an inclined screw conveyor 92 provided within a screen 94 which in turn has a housing 96 provided thereabout, in which water released from the organic material may be collected. The screw conveyor is preferably provided as a shaftless screw, although a partially shafted screw is depicted in FIG. 5. The organic material product 24 is passed into the screw press 90 by way of an inlet 98 provided in the housing 96, in turn near a base 100 of the screw conveyor 92. A motor 102 is provided at the base 100, by which the screw conveyor 92 is driven. The organic material product 24 is conveyed upwardly within the screen 94 toward an outlet end 104 at which is provided an adjustable outlet cap 106. The conveyed organic material bears against the outlet cap 106 at which point the organic material compresses and produces a water flow therefrom. This water flow is collected in a sump 108 that feeds into a water line 110 and which is in turn passed to tank 36 as described hereinabove.

The degree of compression of the organic material in the screw press 90 is governed by the adjustment of the outlet cap 106. The ‘tighter’ the outlet cap 106 the greater the degree of compression imparted to the organic material and the more moisture that is removed therefrom.

As may be noted with reference to the above description, the method and apparatus of the present invention allow management of the viscosity of the water employed in the process. This is achieved in part by not allowing the accumulation of solids within the process. The solids streams produced at various points of the process are moved onward through the process upon separation from the water. This helps maintain the ‘fluidity’ of the streams in the process.

It is envisaged that the method and apparatus of the present invention will allow the management of soluble organics in the water employed. This may be achieved through the exchange of water from the process water storage vessels employed, with the full volume of water engaged in the process preferably being exchanged in a single day, being about 50,000 L. This operation coordinates with the process of digestion in the bioconversion process 28 to which the clean organic fraction is directed.

It is further envisaged that the method of the present invention may be operated to drop out other contaminants of the OFMSW in addition to glass and grit, such as stones, sand and soil, should such be desired by the operators.

Modifications and variations such as would be apparent to the skilled addressee are considered to fall within the scope of the present invention.

1. A separation method comprising the following method steps:
(i) Passing an organic waste material to a primary washing step in which a clean organic stream and a fraction with a specific gravity of greater than 1 are produced;
(ii) Passing the clean organic stream from step (i) to a drainage step to remove free water therefrom; and
(iii) Passing the organic material product of step (ii) to a dewatering step in which the water content of the organic material is reduced to a level suitable for passing to a bioconversion process.

2. A separation method according to claim 1, wherein the fraction with a specific gravity of greater than 1 produced in step (i) is passed to a secondary washing step.

3. A separation method according to claim 1 or 2, wherein process water is fed to at least one tank from which it may be fed in turn to the primary and secondary washing steps.

4. A separation method according to claim 3, wherein at least a portion of the water fed to the tank is passed to a filter means prior to feeding to the primary and secondary washing steps.

5. A separation method according to claim 3 or 4, wherein a further portion of the water fed to the tank is used to clean one or more screens employed in the drainage step and the glass and grit fraction.

6. A separation method according to any one of the preceding claims, wherein the organic waste material is an organic fraction of municipal solid waste.

7. A separation method according to any one of the preceding claims, wherein the fraction with a specific gravity greater than 1 comprises a glass and grit fraction.

8. A separation method according to any one of the preceding claims, wherein the primary washing step comprises directing the organic waste material into a body of water, in which glass and grit settle and light organic material is able to pass over a weir provided in the body of water before passing to the drainage step.

9. A separation method according to claim 8, wherein the secondary washing step is conducted in the same manner as the primary washing step with a view to separating a significant proportion of any organic material entrained with the glass and grit from the primary washing step.

10. A separation method according to any one of the preceding claims, wherein the drainage step comprises the introduction of separated organic material into a trough about which is provided a rotating screen, whereby the organic material is discharged over a weir in the trough onto the rotating screen, in which process the organic material is subjected to a shear force with organic material being held in the screen whilst water passes therethrough.

11. A separation method according to any one of the preceding claims, wherein the dewatering step comprises the passing of the organic product of the drainage step to a screw press having an adjustable outlet cap against which the conveyed organic material bears before leaving the dewatering step.

12. A separation method according to claim 11, wherein the ease with which the organic product is able to pass the adjustable outlet cap governs the subsequent moisture content of the organic product.

13. An apparatus for the separation of organic material from material with a specific gravity greater than 1, comprising a primary washer in which a clean organic stream and a fraction with a specific gravity of greater than 1 are produced, a drainer to remove free water from the clean organic stream, and a dewaterer in which the water content of the organic material is reduced to a level suitable for passing to a bioconversion process.

14. An apparatus according to claim 13, wherein the apparatus further comprises a secondary washer.

15. An apparatus according to claim 13 or 14, wherein the apparatus further comprises at least one tank to and from which water may be fed.

16. An apparatus according to any one of claims 13 to 15, wherein a filter means is provided prior to water being fed to the primary and secondary washers, to the drainer and/or to a glass and grit fraction for cleaning thereof.

17. An apparatus according to any one of claims 13 to 16, wherein the organic waste material is an organic fraction of municipal solid waste.

18. An apparatus according to any one of claims 13 to 17, wherein the fraction with a specific gravity greater than 1 comprises a glass and grit fraction.

19. An apparatus according to any one of claims 13 to 18, wherein the primary washer comprises a body of water, in which glass and grit settle and light organic material is able to pass over a weir provided in the body of water before passing to the drainer.

20. An apparatus according to any one of claims 14 to 19, wherein the secondary washer is provided in substantially the same form as the primary washer, with a view to separating a significant proportion of any organic material entrained with the glass and grit from the primary washing step.

21. An apparatus according to any one of claims 13 to 20, wherein the drainer comprises an elongate trough in which separated organic material is introduced, about which is provided a rotating screen.

22. An apparatus according to claim 21, wherein a weir is provided in the trough whereby the organic material is discharged over that weir onto the rotating screen.

23. An apparatus according to claim 22, wherein the organic material is subjected to a shear force with organic material being held in the screen whilst water passes therethrough.

24. An apparatus according to any one of claims 13 to 23, wherein the dewaterer comprises a screw press having an adjustable outlet cap against which a conveyed organic material bears before leaving the dewaterer.

25. An apparatus according to claim 24, wherein the ease with which the organic product is able to pass the adjustable cap governs the subsequent moisture content of the organic product.

26. A separation method substantially as hereinbefore described with reference to the Figures.

27. An apparatus for the separation of organic material from material with a specific gravity greater than 1, the apparatus being substantially as hereinbefore described with reference to the Figures.
